(19) United States
(12) Patent Application Publication
(10) Pub. No.: US 2025/0038187 A1
(43) Pub. Date: Jan. 30, 2025

(54) SILICON-CLATHRATE ELECTRODE ACTIVE MATERIAL PARTICLES, ELECTRODE COMPOSITE MATERIAL, AND LITHIUM-ION BATTERY

(71) Applicant: TOYOTA JIDOSHA KABUSHIKI KAISHA, Toyota-shi (JP)

(72) Inventors: Mitsutoshi OTAKI, Susono-shi (JP); Jun YOSHIDA, Mishima-shi (JP); Masafumi NOSE, Mishima-shi (JP); Yasuhiro YAMAGUCHI, Kariya-shi (JP); Tatsuya EGUCHI, Kariya-shi (JP); Masanori HARATA, Kariya-shi (JP); Tomohiro NIIMI, Kariya-shi (JP); Kayoko YUKAWA, Kariya-shi (JP); Kota URABE, Kariya-shi (JP)

(73) Assignee: TOYOTA JIDOSHA KABUSHIKI KAISHA, Toyota-shi (JP)

(21) Appl. No.: 18/771,354

(22) Filed: Jul. 12, 2024

(30) Foreign Application Priority Data
Jul. 27, 2023 (JP) 2023-122484

(51) Int. Cl. H01M 4/38; C01B 33/021; H01M 10/0525

(52) U.S. Cl. CPC H01M 4/386; C01B 33/021; H01M 10/0525; C01P 2006/12; C01P 2006/40

(57) ABSTRACT

Silicon-clathrate electrode active material particles of this disclosure meet the following relational expression: 0<surface oxygen ratio (wt %)/specific surface area (m²/g)<0.3. An electrode composite material of this disclosure includes the electrode active material particles of this disclosure. Further, a lithium-ion battery of this disclosure has an electrode active material layer, and the electrode active material layer contains the electrode composite material of this disclosure.

### CROSS-REFERENCE TO RELATED APPLICATION

This application claims priority to Japanese Patent Application No. 2023-122484 filed on Jul. 27, 2023, incorporated herein by reference in its entirety.

### BACKGROUND

### 1. Technical Field

This disclosure relates to silicon-clathrate electrode active material particles, an electrode composite material, and a lithium-ion battery.

### 2. Description of Related Art

In recent years, development of batteries has been vigorously conducted. For example, the automobile industry has been pursuing the development of batteries used for battery electric vehicles or hybrid electric vehicles. Further, silicon is known as an electrode active material used for batteries, particularly lithium-ion batteries.

Having high theoretical capacities, silicon electrode active materials are effective in increasing the energy densities of batteries. On the other hand, there is a problem that silicon electrode active materials expand significantly during charging. To address this problem, one known measure is to mitigate the expansion during charging by using a silicon-clathrate electrode active material as a silicon electrode active material.

For example, Japanese Unexamined Patent Application Publication No. 2021-158003 discloses a silicon-clathrate electrode active material that has a type-II silicon clathrate crystal phase and has a composition of NaₓSi₁₃₆ (1.98<x<2.54).

### SUMMARY

While expansion during charging of a silicon-clathrate electrode active material can be reduced compared with that of an ordinary silicon electrode active material, it is desired to further reduce the expansion of a silicon-clathrate electrode active material during charging.

This disclosure aims to provide electrode active material particles that expand insignificantly during charging and a lithium-ion battery that has such electrode active material particles.

The present disclosers found that the above-described challenge can be solved by the following means:

### <Aspect 1>

Silicon-clathrate electrode active material particles that meet the following relational expression:

$$0 < surface oxygen ratio ( wt \% ) / specific surface area ( {m}^{2} / g ) < 0.3 .$$

### <Aspect 2>

The electrode active material particles according to Aspect 1 that meet the following relational expression:

$$0.05 \leq surface oxygen ratio ( wt \% ) / specific surface area ( {m}^{2} / g ) \leq 0.1 .$$

### <Aspect 3>

The electrode active material particles according to Aspect 1 or 2 that have a porous structure.

### <Aspect 4>

An electrode composite material including the electrode active material particles according to any one of Aspects 1 to 3.

### <Aspect 5>

A lithium-ion battery that has an electrode active material layer, wherein the electrode active material layer contains the electrode composite material according to Aspect 4.

According to this disclosure, electrode active material particles that expand insignificantly during charging and a lithium-ion battery that has such electrode active material particles can be provided.

### DETAILED DESCRIPTION OF EMBODIMENTS

Embodiments of this disclosure will be described in detail below. This disclosure is not limited to the following embodiments and can be implemented with various changes within the scope of the gist of this disclosure.

### Silicon-Clathrate Electrode Active Material Particles

Silicon-clathrate electrode active material particles of this disclosure meet the following relational expression:

$$0 < surface oxygen ratio ( wt \% ) / specific surface area ( {m}^{2} / g ) < 0.3 .$$

It has been believed that surfaces of silicon electrode active material particles being as little oxidized as possible is preferable, because the electrical conductivity of the silicon electrode active material particles decreases when the surfaces of the silicon electrode active material particles become oxidized and turn into oxide silicon having an insulating property.

However, the present disclosers found that silicon-clathrate electrode active material particles that were moderately surface-oxidized exhibited a smaller variation in restraining pressure when used for a battery. Without being bound by any theory, this seems to be attributable to the following effects that occur when surfaces of silicon electrode active material particles are moderately oxidized: In other words, when silicon electrode active material particles are used as a battery, oxide silicon in surfaces reacts with lithium and turns into lithium silicate that has excellent ionic conductivity compared with oxide silicon, which can presumably reduce the unevenness of a reaction between silicon-clathrate electrode active material particles and lithium, without excessively hindering electronic conduction owing to the small thickness of the lithium silicate.

Regarding this disclosure, an “electrode active material” can be used both as a “positive electrode active material” and as a “negative electrode active material”, and is used particularly as a “negative electrode active material”.

The surface oxygen ratio (wt %)/specific surface area (m²/g) may be 0.01 or higher, 0.03 or higher, 0.05 or higher, 0.06 or higher, or 0.07 or higher, and may be 0.25 or lower, 0.20 or lower, 0.15 or lower, or 0.10 or lower.

The surface oxygen ratio of the electrode active material particles may be higher than 0 wt %, 0.5 wt % or higher, 1.0 wt % or higher, 1.5 wt % or higher, 2.0 wt % or higher, 2.5 wt % or higher, 3.0 wt % or higher, or 3.5 wt % or higher, and may be 30 wt % or lower, 25 wt % or lower, 20 wt % or lower, 15 wt % or lower, 10 wt % or lower, 8.0 wt % or lower, or 6.0 wt % or lower.

A method of measuring the surface oxygen ratio of the electrode active material particles is not particularly limited, and one example is a method of calculating the surface oxygen ratio from an analytical value obtained by an elemental analysis using an oxygen-nitrogen-hydrogen analysis device, or by SEM-EDX, XPS, AES or the like. For example, when using an oxygen-nitrogen-hydrogen analysis device, the surface oxygen ratio can be calculated from a result of measurement by a non-dispersive infrared absorption method after melting the electrode active material particles with an oxygen gas using EMGA-930 of HORIBA, Ltd.

The specific surface area of the electrode active material particles may be 15 m²/g or larger, 25 m²/g or larger, 35 m²/g or larger, 45 m²/g or larger, or 50 m²/g or larger, and may be 100 m²/g or smaller, 90 m²/g or smaller, 80 m²/g or smaller, 75 m²/g or smaller, or 70 m²/g or smaller.

A method of calculating the specific surface area of the electrode active material particles is not particularly limited, and one example is a method of calculating the specific surface area by the BET method. Specifically, the specific surface area can be calculated by analyzing, using the BET method, a surface area that is measured by a low-dosage adsorption method (nitrogen gas adsorption method) using a nitrogen gas. For this analysis, for example, BELSORP MAX II of MicrotracBEL Corp. can be used.

Examples of a method of manufacturing the electrode active material particles of this disclosure include, but are not limited to, a method involving obtaining a sodium-silicon (NaSi) alloy in powder form by mixing a silicon raw material and a sodium source together and heating this mixture into an alloy, and obtaining a silicon clathrate by mixing the obtained NaSi alloy and aluminum fluoride together and heating this mixture so as to form a clathrate.

Examples of the sodium source in the alloying step include sodium hydride, but are not limited thereto.

A heating temperature in the alloying step may be 300° C. or higher, 350° C. or higher, or 380° C. or higher, and may be 500° C. or lower, 450° C. or lower, or 420° C. or lower. Further, a heating time may be 20 hours or longer, 30 hours or longer, or 35 hours or longer, and may be 60 hours or shorter, 50 hours or shorter, or 45 hours or shorter.

A heating temperature in the clathrate formation step may be 250° C. or higher, 280° C. or higher, or 300° C. or higher, and may be 400° C. or lower, 380° C. or lower, or 350° C. or lower. Further, a heating time may be 10 hours or longer, 15 hours or longer, or 20 hours or longer, and may be 70 hours or shorter, 65 hours or shorter, or 60 hours or shorter.

The surface oxygen ratio and the specific surface area of the silicon-clathrate electrode active material particles can be controlled by, for example, adjusting the heating temperature and the heating time in the alloying step and the heating temperature and the heating time in the clathrate formation step.

The electrode active material particles may be further washed with a hydrogen fluoride solution. The surface oxygen ratio and the specific surface area of the electrode active material particles can be controlled also by thus washing the electrode active material particles with a hydrogen fluoride solution.

The electrode active material particles of this disclosure may have a porous structure. A porous silicon clathrate can absorb expansion due to charging and discharging by its voids.

Examples of a method of manufacturing the electrode active material particles of this disclosure in the case where these particles are porous silicon clathrate particles include, but are not limited to, a method involving obtaining a lithium-silicon (LiSi) alloy by mixing silicon and metallic lithium together, obtaining porous silicon by making the obtained LiSi alloy react with ethanol, and obtaining a silicon clathrate as described above using the obtained porous silicon as the silicon raw material.

The specific surface area of the electrode active material particles can be controlled also by thus adopting a porous structure for the electrode active material particles.

### Electrode Composite Material

An electrode composite material of this disclosure includes electrode active material particles. The electrode composite material of this disclosure optionally contains a solid electrolyte, a conductive agent, and a binder.

### Electrode Active Material Particles

For the electrode active material particles, the above description relating to the electrode active material particles of this disclosure can be referred to.

### Solid Electrolyte

A material of the solid electrolyte is not particularly limited, and materials that are available as solid electrolytes used for lithium-ion batteries can be used. For example, the solid electrolyte may be a sulfide solid electrolyte.

Examples of the sulfide solid electrolyte include, but are not limited to, a sulfide amorphous solid electrolyte, a sulfide crystalline solid electrolyte, and an argyrodite-type solid electrolyte. Specific examples of the sulfide solid electrolyte can include, but are not limited to, an Li₂S—P₂S₅-based material (Li₇P₃S₁₁, Li₃PS₄, Li₈P₂S₉ and the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂ and the like), LiI—Li₂S—P₂O₅, LiI—Li₃PO₄—P₂S₅, Li₇₋ₓPS₆₋ₓClₓ, or combinations of these materials.

The sulfide solid electrolyte may be glass or may be crystallized glass (glass ceramic).

### Conductive Agent

The conductive agent is not particularly limited. For example, the conductive agent may be vapor-grown carbon fiber (VGCF), acetylene black (AB), ketjen black (KB), carbon nanotube (CNT), or carbon nanofiber (CNF), but is not limited to these materials.

### Binder

The binder is not particularly limited. For example, the binder may be a material such as polyvinylidene fluoride (PVdF), butadiene rubber (BR), styrene-butadiene rubber (SBR), or a combination of these materials, but is not limited to these examples.

Regarding this disclosure, an “electrode composite material” means a compound that can constitute an electrode active material layer by itself or by further containing other components. Further, regarding this disclosure, “electrode composite material slurry” means slurry that includes a dispersion medium in addition to an “electrode composite material” and can be thereby applied and dried to form an electrode active material layer.

### Lithium-Ion Battery

A lithium-ion battery of this disclosure may be an aqueous battery or a solid-state battery. Regarding this disclosure, a “solid-state battery” means a battery that uses at least a solid electrolyte as the electrolyte, and therefore the solid-state battery may use a combination of a solid electrolyte and a liquid electrolyte as the electrolyte. Further, the solid-state battery of this disclosure may be an all-solid-state battery, i.e., a battery that uses only a solid electrolyte as the electrolyte.

The lithium-ion battery of this disclosure can be restrained by restraining members, such as end plates, from both sides in a stacking direction of the above-described layers. Examples of a restraining method include a method of using restraining torque of a bolt, but are not limited thereto.

The lithium-ion battery of this disclosure has an electrode active material layer, and the electrode active material layer contains the electrode composite material of this disclosure. In particular, in the lithium-ion battery of this disclosure, a negative electrode composite material may be the electrode composite material of this disclosure, and in this case, the lithium-ion battery may include a negative electrode current collector layer, a negative electrode active material layer containing the electrode composite material of this disclosure, a solid electrolyte layer, a positive electrode active material layer, and a positive electrode current collector layer in this order.

### Negative Electrode Current Collector Layer

A material used for the negative electrode current collector layer is not particularly limited, and materials that can be used as negative electrode current collectors of batteries can be adopted as appropriate. Examples may include, but are not limited to, copper, a copper alloy, and a material obtained by plating copper with, or depositing thereon, nickel, chromium, carbon and the like.

A form of the negative electrode current collector layer is not particularly limited, and examples can include a foil form, a plate form, or a mesh form. Among these forms, a foil form is preferable.

### Negative Electrode Active Material Layer

The negative electrode active material layer contains the electrode composite material of this disclosure. For the electrode composite material, the above description relating to the electrode composite material of this disclosure can be referred to.

When the negative electrode active material layer contains a solid electrolyte, a mass ratio between the electrode active material particles and the solid electrolyte (the mass of the electrode active material particles:the mass of the solid electrolyte) in the negative electrode active material layer is preferably 85:15 to 30:70 and more preferably 80:20 to 40:60.

A thickness of the negative electrode active material layer may be, for example, 0.1 to 1000 μm.

### Solid Electrolyte Layer

The solid electrolyte layer includes at least a solid electrolyte. Further, other than the solid electrolyte, the solid electrolyte layer may include a binder as necessary. For the solid electrolyte and the binder, the above description relating to the electrode composite material of this disclosure can be referred to.

A thickness of the solid electrolyte layer is, for example, 0.1 to 300 μm and preferably 0.1 to 100 μm.

### Positive Electrode Active Material Layer

The positive electrode active material layer is a layer that contains a positive electrode active material, and optionally a solid electrolyte, a conductive agent, a binder, a thickening agent and the like.

A material of the positive electrode active material is not particularly limited. For example, the positive electrode active material may be lithium cobaltate (LiCoO₂), lithium nickelate (LiNiO₂), lithium manganate (LiMn₂O₄), LiCo_{1/3}Ni_{1/3}Mn_{1/3}O₂, heteroelement-substituted Li—Mn spinel with a composition represented by Li₁₊ₓMn_{2-x-y}MyO₄ (M is one or more metal elements selected from Al, Mg, Co, Fe, Ni, and Zn), lithium titanate (LiₓTiO_{y}), or metal lithium phosphate (LiMPO₄, with M being one or more metals selected from Fe, Mn, Co, and Ni), but is not limited to these materials.

The positive electrode active material can have a coating layer. The coating layer is a layer containing a substance that has a lithium-ion conduction capacity, has low reactivity with a positive electrode active material and a solid electrolyte, and can maintain the form of the coating layer so as not to flow on contact with an active material or a solid electrolyte. Specific examples of a material composing the coating layer can include Li₄Ti₅O₁₂ and Li₃PO₄ other than LiNbO₃, but are not limited to these materials.

One example of a form of the positive electrode active material is a particle form. A mean particle diameter (D50) of the positive electrode active material is not particularly limited, and is, for example, 10 nm or larger and may be 100 nm or larger. On the other hand, the mean particle diameter (D50) of the positive electrode active material is, for example, 50 μm or smaller and may be 20 μm or smaller. The mean particle diameter (D50) can be calculated, for example, based on measurement by a laser diffraction particle size distribution analyzer or a scanning electron microscope (SEM).

For the solid electrolyte, the conductive agent, and the binder, the above description relating to the electrode composite material of this disclosure can be referred to.

When the positive electrode active material layer contains a solid electrolyte, a mass ratio between the positive electrode active material and the solid electrolyte (the mass of the positive electrode active material:the mass of the solid electrolyte) in the positive electrode active material layer is preferably 85:15 to 30:70 and more preferably 80:20 to 50:50.

A thickness of the positive electrode active material layer is, for example, 0.1 μm to 1000 μm, preferably 1 μm to 100 μm, and further preferably 30 μm to 100 μm.

### Positive Electrode Current Collector Layer

A material used for the positive electrode current collector layer is not particularly limited, and materials that can be used as positive electrode current collectors of batteries can be adopted as appropriate. Examples may include, but are not limited to, SUS, nickel, chromium, gold, platinum, aluminum, iron, titanium, zinc, and materials obtained by plating these metals with, or depositing thereon, nickel, chromium, carbon and the like.

A form of the positive electrode current collector layer is not particularly limited, and examples can include a foil form, a plate form, or a mesh form. Among these forms, a foil form is preferable.

### Example 1

### Synthesis of Silicon-Clathrate Electrode Active Material Particles Imparting Porousness

As a silicon (Si) source, an Si powder (SIEPB32 of Kojundo Chemical Laboratory. Co., Ltd.) was prepared. Metallic lithium (Li) and this Si powder were weighed to be a molar ratio of Li:Si=4:1, and the weighed Li and Si powder were mixed together in a mortar and made to react with each other in an argon atmosphere under the conditions of room temperature and 0.5 hours to obtain lithium silicon (Li₄Si). The obtained Li₄Si was let stand in an argon atmosphere and made to react with ethanol. Further, the reaction product was washed with a 3 wt % hydrogen fluoride (HF) solution and then filtered, and a solid content filtered out was dried at 120° C. for three hours or longer to obtain an Si powder having a porous structure.

### Alloying

Using the Si powder having a porous structure and sodium hydride (NaH) as a sodium (Na) source, a sodium-silicon (NaSi) alloy was produced. The NaH used had been washed with hexane in advance. The NaH and the Si powder having a porous structure were weighed to be a molar ratio of 1.05:1, and the weighed NaH and Si powder having a porous structure were mixed together by a cutter mill. The obtained mixture was heated by a heating furnace in an argon atmosphere under the conditions of 400° C. and 40 hours to obtain an NaSi alloy in powder form.

### Forming Clathrate

The obtained NaSi alloy and aluminum fluoride (AlF₃) particles were weighed to be a molar ratio of 1:0.35, and the weighed NaSi alloy and AlF₃ particles were mixed together by a cutter mill to obtain a reaction raw material. The obtained reaction raw material in powder form was put into a stainless-steel reaction container, and was heated and made to react by a heating furnace in an argon atmosphere under the conditions of 345° C. and 40 hours to obtain a silicon clathrate. The obtained silicon clathrate was acid-washed using a mixed solvent of HNO₃ and H₂O mixed together to a volume ratio of 10:90 to remove by-products in the reaction product. After washing, the reaction product was filtered, and a solid content filtered out was dried at 120° C. for three hours or longer to obtain silicon-clathrate electrode active material particles having a porous structure.

### Example 2

Silicon-clathrate electrode active material particles having a porous structure were obtained in the same manner as in Example 1, except that heating was performed under the conditions of 345° C. and 60 hours in forming a clathrate, and that after acid washing and the subsequent filtration and drying, the particles were further washed with a 3 wt % HF solution and filtered and then dried at 120° C. for three hours or longer.

### Example 3

Silicon-clathrate electrode active material particles having a porous structure were obtained in the same manner as in Example 2, except that heating was performed under the conditions of 335° C. and 60 hours in forming a clathrate.

### Example 4

Silicon-clathrate electrode active material particles having a porous structure were obtained in the same manner as in Example 2, except that heating was performed under the conditions of 325° C. and 60 hours in forming a clathrate.

### Example 5

Silicon-clathrate electrode active material particles having a porous structure were obtained in the same manner as in Example 2, except that heating was performed under the conditions of 345° C. and 40 hours in forming a clathrate.

### Example 6

Silicon-clathrate electrode active material particles having a porous structure were obtained in the same manner as in Example 2, except that heating was performed under the conditions of 345° C. and 20 hours in forming a clathrate.

### Example 7

### Alloying

Using an Si powder (SIEPB32 of Kojundo Chemical Laboratory. Co., Ltd.) and sodium hydride (NaH) as a sodium (Na) source, a sodium-silicon (NaSi) alloy was produced. The NaH used had been washed with hexane in advance. The NaH and the Si powder having a porous structure were weighed to be a molar ratio of 1.05:1, and the weighed NaH and Si powder were mixed together by a cutter mill. The obtained mixture was heated by a heating furnace in an argon atmosphere under the conditions of 400° C. and 40 hours to obtain an NaSi alloy in powder form.

### Forming Clathrate

The obtained NaSi alloy and aluminum fluoride (AlF₃) particles were weighed to be a molar ratio of 1:0.35, and the weighed NaSi alloy and AlF₃ particles were mixed together by a cutter mill to obtain a reaction raw material. The obtained reaction raw material in powder form was put into a stainless-steel reaction container, and was heated and made to react by a heating furnace in an argon atmosphere under the conditions of 345° C. and 40 hours to obtain a silicon clathrate. The obtained silicon clathrate was acid-washed using a mixed solvent of HNO₃ and H₂O mixed together to a volume ratio of 10:90 to remove by-products in the reaction product. After washing, the reaction product was filtered, and a solid content filtered out was dried at 120° C. for three hours or longer. Further, the obtained silicon clathrate was washed with a 3 wt % HF solution and filtered and then dried at 120° C. for three hours or longer to obtain silicon clathrate particles.

### Imparting Porousness

Li and the obtained silicon clathrate particles were weighed to be a molar ratio of 2.5:1, and the weighed Li and Si powder were mixed together in a mortar and made to react with each other in an argon atmosphere under the conditions of room temperature and 0.5 hours to obtain lithium silicon (Li_{2.5}Si). The obtained Li_{2.5}Si was let stand in an argon atmosphere and made to react with ethanol. Thus, silicon-clathrate electrode active material particles having a porous structure were obtained.

### Comparative Example 1

Silicon-clathrate electrode active material particles of Comparative Example 1 were obtained in the same manner as in Example 2, except that in alloying, an Si powder (SIEPB32 of Kojundo Chemical Laboratory. Co., Ltd.) was used instead of an Si powder having a porous structure.

Surfaces of the electrode active material particles of each of the above-described Examples may include coatings or impurities containing an O element, a C element, or an N element.

### Production of Lithium-Ion Battery

### Preparation of Negative Electrode Composite Material

In a polypropylene container, a 5 wt % butyl butyrate solution of butyl butyrate and polyvinylidene fluoride (PVDF)-based binder, vapor-grown carbon fiber (VGCF) as a conductive agent, the electrode active material particles of each Example, and Li₂S—P₂S₅-based glass ceramic as a sulfide solid electrolyte were added and stirred for 30 seconds using an ultrasonic dispersion device (UH-50 of SMT Co., Ltd.) Next, the container was shaken for 30 minutes using a shaker (TTM-1 of SIBATA SCIENTIFIC TECHNOLOGY LTD.) to obtain a negative electrode composite material in slurry form (negative electrode composite material slurry).

### Formation of Negative Electrode Active Material Layer

The obtained negative electrode composite material slurry was applied to a copper (Cu) foil as a negative electrode current collector layer by a blade method using an applicator, and was dried for 30 minutes on a hot plate heated to 100° C. to form a negative electrode active material layer on the negative electrode current collector layer.

### Formation of Solid Electrolyte Layer

In a polypropylene container, a 5 wt % heptane solution of heptane and butylene rubber (BR)-based binder, and Li₂SP₂S₅-based glass ceramic as a sulfide solid electrolyte were added and stirred for 30 seconds using an ultrasonic dispersion device (UH-50 of SMT Co., Ltd.) Next, the container was shaken for 30 minutes using a shaker (TTM-1 of SIBATA SCIENTIFIC TECHNOLOGY LTD.) to obtain solid electrolyte slurry.

The obtained solid electrolyte slurry was applied to an aluminum (Al) foil as a release sheet by the blade method using an applicator, and was dried for 30 minutes on a hot plate heated to 100° C. to form a solid electrolyte layer. A plurality of solid electrolyte layer was produced.

### Preparation of Positive Electrode Composite Material

In a polypropylene container, a 5 wt % butyl butyrate solution of butyl butyrate and a PVDF-based binder, LiNi_{1/3}Co_{1/3}Mn_{1/3}O₂ having a mean particle diameter of 6 μm as a positive electrode active material, Li₂S—P₂S₅-based glass ceramic as a sulfide solid electrolyte, and VGCF as a conductive agent were added and stirred for 30 seconds using an ultrasonic dispersion device (UH-50 of SMT Co., Ltd.) Next, the container was shaken for three minutes using a shaker (TTM-1 of SIBATA SCIENTIFIC TECHNOLOGY LTD.). Further, the materials were stirred for 30 seconds using the ultrasonic dispersion device and the container was shaken for three minutes to obtain a positive electrode composite material in slurry form (positive electrode composite material slurry).

### Formation of Positive Electrode Active Material Layer

The obtained positive electrode composite material slurry was applied to an Al foil as a positive electrode current collector layer by the blade method using an applicator, and was dried for 30 minutes on a hot plate heated to 100° C. to form a positive electrode active material layer on the positive electrode current collector layer.

### Assembly of Battery

The positive electrode current collector layer, the positive electrode active material layer, and a first solid electrolyte layer were stacked in this order. This stack was set in a roll press machine and pressed at a pressing pressure of 100 kN/cm and a pressing temperature of 165° C. to obtain a positive electrode stack.

The negative electrode current collector layer, the negative electrode active material layer, and a second solid electrolyte layer were stacked in this order. This stack was set in a roll press machine and pressed at a pressing pressure of 60 kN/cm and a pressing temperature of 25° C. to obtain a negative electrode stack.

Further, the Al foils as the release sheets were released from surfaces of the solid electrolyte layers of the positive electrode stack and the negative electrode stack. Next, the Al foil as the release sheet was released from a third solid electrolyte layer.

The positive electrode stack, the negative electrode stack, and the third solid electrolyte layer were stacked such that solid electrolyte layer sides of these stacks and the third solid electrolyte layer face each other, and the obtained stack was set in a flat single-axis press machine and temporarily pressed for 10 seconds at 100 MPa and 25° C., and finally this stack was set in the flat single-axis press machine and pressed for one minute at a pressing pressure of 200 MPa and a pressing temperature of 120° C. Thus, an all-solid-state battery was obtained.

### Evaluation

### Surface Oxygen Ratio

The surface oxygen ratio of the electrode active material particles was calculated from a result of measurement by a non-dispersive infrared absorption method after melting the particles with an oxygen gas using an oxygen-nitrogen-hydrogen analysis device (EMGA-930 of HORIBA, Ltd.).

### Specific Surface Area

The specific surface area of the electrode active material particles was calculated by analyzing, using the BET method, a surface area that was measured by a low-dosage adsorption method (nitrogen gas adsorption method) using a nitrogen gas. For this analysis, BELSORP MAX II of MicrotracBEL Corp. was used.

### Measurement of Amount of Increase in Restraining Pressure

A produced cell was restrained using a restraining jig under a predetermined restraining pressure, and an amount of increase in the restraining pressure when constant-current, constant-voltage charging was performed up to 4.55 V at a 10-hour rate (1/10C) was measured. That this amount of increase in the restraining pressure is large means that an amount of expansion of the active material is large. The amount of increase in the restraining pressure is a difference between a maximum value and a minimum value of the restraining pressure, and the values in Examples are indicated as relative values with the value in Comparative Example 1 being 100.

### Results

Table 1 shows the measurement results of the surface oxygen ratios and the specific surface areas of the electrode active material particles, the values of surface oxygen ratio (wt %)/specific surface area (m²/g) calculated from these results, and the measurement results of the amounts of increase in the restraining pressure.

TABLE 1

| | Surface | Specific | Surface oxygen | Amount of |
|---|---|---|---|---|
| | oxygen | surface | ratio [wt %]/ | increase in |
| | ratio | area | specific surface | restraining |
| | [wt %] | [m²/g] | area [m²/g] | pressure |
| Comparative | 4.20 | 13.0 | 0.3231 | 100 |
| Example 1 | | | | |
| Example 1 | 18.80 | 70.0 | 0.2686 | 53 |
| Example 2 | 5.84 | 55.9 | 0.1045 | 57 |
| Example 3 | 5.68 | 57.7 | 0.0984 | 37 |
| Example 4 | 5.87 | 65.9 | 0.0891 | 40 |
| Example 5 | 4.72 | 56.6 | 0.0834 | 23 |
| Example 6 | 3.89 | 53.4 | 0.0728 | 30 |
| Example 7 | 2.00 | 70.0 | 0.0286 | 67 |

As shown in Table 1, the batteries of Examples including the electrode active material particles that fell within the range of surface oxygen ratio (wt %)/specific surface area (m²/g) of this disclosure exhibited smaller amounts of increase in the restraining pressure than the battery of Comparative Example.

What is claimed is:

1. Silicon-clathrate electrode active material particles that meet the following relational expression:
0<surface oxygen ratio (wt %)/specific surface area (m²/g)<0.3.

2. The electrode active material particles according to claim 1 that meet the following relational expression:
0.05≤surface oxygen ratio (wt %)/specific surface area (m²/g)≤0.1.

3. The electrode active material particles according to claim 1 that have a porous structure.

4. An electrode composite material including the electrode active material particles according to claim 1.

5. A lithium-ion battery that has an electrode active material layer, wherein the electrode active material layer contains the electrode composite material according to claim 4.
